(19) United States
(12) Patent Application Publication
(10) Pub. No.: US 2021/0142599 A1
(43) Pub. Date: May 13, 2021

(54) PORTABLE MACHINE

(71) Applicant: KABUSHIKI KAISHA TOKAI RIKA DENKI SEISAKUSHO, Aichi (JP)

(72) Inventors: Tetsuya KAWAMURA, Aichi (JP); Hiroaki KOJIMA, Aichi (JP); Masayuki KAWAMURA, Aichi (JP); Tomohiko ISHIGAKI, Aichi (JP)

(73) Assignee: KABUSHIKI KAISHA TOKAI RIKA DENKI SEISAKUSHO, Aichi (JP)

(21) Appl. No.: 16/616,702

(22) PCT Filed: May 29, 2018
(86) PCT No.: PCT/JP2018/020433

§ 371 Date: Nov. 25, 2019

(30) Foreign Application Priority Data
May 31, 2017 (JP) 2017-107637

(51) Int. Cl. G07C 9/00; B60R 25/24

(52) U.S. Cl. CPC G07C 9/00309; G07C 2009/00793; B60R 25/24

(57) ABSTRACT

A portable device includes a vibration sensor and a determination unit. The determination unit determines that vibration is detected when an amount of vibration applied to the portable device exceeds a determination threshold that is indicative of a vibration detection sensitivity of the vibration sensor. The determination unit selects one of determination thresholds that are indicative of different vibration detection sensitivities and determines whether or not vibration is detected based on the selected determination threshold.

### TECHNICAL FIELD

The present invention relates to a portable device that includes a vibration sensor.

### BACKGROUND ART

An ECU of a vehicle to which a SMART KEY SYSTEM (registered trademark) is applied transmits a low-frequency LF signal from a transmitter and forms an exterior communication area around a door in order to monitor an approaching portable device, which is carried by an owner as a vehicle key. When the owner carrying the portable device enters the exterior communication area, the portable device automatically transmits a high-frequency RF signal that includes a key code unique to the portable device in response to the LF signal.

A key code of an authorized portable device corresponding to the vehicle is registered as a reference key code in the vehicle ECU. When the ECU receives the RF signal with a receiver, the ECU checks the RF signal. If the RF signal includes a key code that corresponds to the reference key code, the ECU determines that key authentication has been accomplished and permits unlocking of the door. In this case, the owner touches a door handle to actually unlock the door.

A known technique installs a vibration sensor in the portable device of the smart key system and switches ON and OFF a function for receiving an LF signal in accordance with whether or not the vibration sensor detects vibration (refer to Patent Documents 1 to 3). With this technique, if the vibration sensor detects vibration of the portable device, the portable device is determined as being carried by an owner. Thus, the function for receiving an LF signal is switched ON. Accordingly, when the owner enters the exterior communication area, bidirectional communication, which is referred to as smart communication, is established between the vehicle and the portable device. Further, key authentication is accomplished through the smart communication. This allows the owner to smoothly enter the vehicle.

If the vibration sensor does not detect vibration of the portable device, the portable device is determined as not being carried and stored in a stationary state in a house or the like. Thus, the function for receiving an LF signal is switched OFF. This reduces the power consumed when waiting to receive an LF signal so that a battery of the portable device is not exhausted in the stored state. In addition, smart communication that is not intended by the owner is restricted. This improves security against unauthorized actions performed with a relay.

### PRIOR ART DOCUMENTS

### Patent Documents

Patent Document 1: Japanese Laid-Open Patent Publication No. 2016-56659
Patent Document 2: Japanese Laid-Open Patent Publication No. 2011-184959
Patent Document 3: Japanese Laid-Open Patent Publication No. 11-71948

### SUMMARY OF THE INVENTION

### Problem that the Invention is to Solve

If the function for receiving an LF signal is inadvertently switched OFF when the owner stops inside the exterior communication area, smart communication will not be established even though the authorized portable device is in the exterior communication area. In this case, the owner cannot unlock the door. Further, if the function for receiving an LF signal is switched ON by vibration produced in a household environment when the portable device is in the stored state, power consumption of the portable device will increase and smart communication that is not intended by the owner may be established.

It is an objective of the present invention to provide a portable device that detects vibration with sensitivity that is in accordance with usage situations.

### Means for Solving the Problem

According to one embodiment, a portable device includes a vibration sensor. The portable device includes a determination unit that determines that vibration is detected when an amount of vibration applied to the portable device exceeds a determination threshold that is indicative of a vibration detection sensitivity of the vibration sensor. The determination unit selects one of determination thresholds that are indicative of different vibration detection sensitivities and determines whether or not vibration is detected based on the selected determination threshold.

With this configuration, one of the determination thresholds is selected to change the vibration detection sensitivity. This allows for vibration detection to be performed with sensitivity that is in accordance with usage situations.

The portable device may include a reception unit that receives a polling signal transmitted from a device serving as a communication peer of the portable device. When the reception unit receives the polling signal, the determination unit may select one of the determination thresholds that is indicative of a higher sensitivity than when the polling signal is not received by the reception unit and determine whether or not vibration is detected in a high sensitivity mode.

With this configuration, the vibration detection sensitivity is increased in the usage situation where the portable device is in a communication area of polling signals so that detection of vibration is determined even when the vibration amount is small.

In the portable device, when the reception unit does not receive the polling signal in the high sensitivity mode, the determination unit may select one of the determination thresholds that is indicative of a lower sensitivity than the high sensitivity mode and determine whether or not vibration is detected in a standard sensitivity mode. Further, when the determination unit does not determine that vibration is detected for a fixed period of time in the standard sensitivity mode, the determination unit may select one of the determination thresholds that is indicative of a lower sensitivity than the standard sensitivity mode and determine whether or not vibration is detected in a low sensitivity mode.

With this configuration, whether or not vibration has been detected is determined in the standard sensitivity mode and the low sensitivity mode in addition to the high sensitivity mode in accordance with the usage situations.

In the portable device, in the high sensitivity mode, the determination unit may always determine that vibration is detected. In the standard sensitivity mode or the low sensitivity mode, the determination unit may determine that vibration is detected when an amount of vibration exceeding the corresponding determination threshold is applied to the portable device. Further, the determination unit may switch ON a function for receiving the polling signal with the reception unit when determining that vibration has been detected and switch OFF the function for receiving the polling signal with the reception unit when determining that vibration has not been detected.

With this configuration, communication can be kept established with the device in the high sensitivity mode. Further, power consumed when waiting to receive a signal can be reduced and unnecessary establishment of communication can be restricted in the low sensitivity mode, and the standard sensitivity mode serves as the intermediate function.

In the portable device, in the low sensitivity mode, the determination unit may select a first determination threshold from the determination thresholds. In the standard sensitivity mode, the determination unit may select a second determination threshold from the determination thresholds by which detection of vibration is more likely to be determined than the first determination threshold. In the high sensitivity mode, the determination unit may select a third determination threshold from the determination thresholds by which detection of vibration is always determined.

With this configuration, the low sensitivity mode determines whether or not vibration has been detected based on the first determination threshold by which detection of vibration is least likely to be determined. As long as the portable device is stored in a stationary state, the detection of vibration is less likely to be determined even when vibration is generated in a household environment. Thus, the function for receiving a polling signal remains switched OFF. The high sensitivity mode determines whether or not vibration has been detected based on the third determination threshold by which detection of vibration is always determined. As long as the portable device is in the communication area of polling signals, the function for receiving a polling signal remains switched ON. Accordingly, the sensitivity is optimized in accordance with the usage situations.

### Effect of the Invention

The present invention allows for vibration detection to be performed with sensitivity that is in accordance with usage situations.

### BRIEF DESCRIPTION OF THE DRAWINGS

FIG. 1 is a block diagram illustrating the configuration of a smart key system.

FIG. 2 is a diagram illustrating the shifting of states by a portable device.

FIG. 3A is a diagram illustrating usage situations of the portable device.

FIG. 3B is a diagram illustrating a sensitivity mode that is in accordance with usage situations.

### EMBODIMENTS OF THE INVENTION

A portable device according to one embodiment will now be described.

As illustrated in FIG. 1, a SMART KEY SYSTEM (registered trademark) 1 performs smart communication, which is bidirectional wireless communication, between a vehicle 2 and a portable device 3 and unlocks a door on condition that key authentication has been accomplished through smart communication.

The vehicle 2 includes a verification ECU 21 that executes vehicle security control, an LF transmitter 22 that transmits a low-frequency LF signal (such as a polling signal on radio waves in the LF band), and an RF receiver 23 that receives a high-frequency RF signal (such as a response signal on radio waves in the UHF band). The vehicle 2 corresponds to a device that serves as a communication peer of the portable device 3.

The verification ECU 21 transmits a polling signal from the LF transmitter 22 and forms an exterior communication area around a door in order to monitor the portable device 3 approaching the vehicle 2. When an owner carrying the portable device 3 enters the exterior communication area, the portable device 3 automatically transmits a response signal that includes a key code unique to the portable device 3 in response to the polling signal.

The verification ECU 21 stores, as a reference key code, one or more key codes of the authorized portable device 3 that correspond to the vehicle. When the verification ECU 21 receives the response signal with the RF receiver 23, the verification ECU 21 checks the response signal. If the response signal includes a key code that corresponds to the reference key code, the verification ECU 21 determines that key authentication has been accomplished and permits unlocking of the door. In this case, the owner, for example, touches a door handle to actually unlock the door.

The portable device 3, which serves a vehicle key, includes a microcomputer 31 that comprehensively controls the portable device 3, an LF reception circuit 32 that receives an LF signal, and an RF transmission circuit 33 that transmits an RF signal. When the microcomputer 31 receives a polling signal with the LF reception circuit 32, the microcomputer 31 transmits a response signal from the RF transmission circuit 33. The LF reception circuit 32 is an example of a reception unit.

The portable device 3 also includes a vibration sensor 34, which serves as a device that detects vibration applied to the portable device 3. The microcomputer 31 determines that vibration has been detected if the amount of vibration applied to the portable device 3 exceeds a determination threshold that is indicative of the vibration detection sensitivity of the vibration sensor 34. The microcomputer 31 is one example of a determination unit.

One example of a determination threshold at which the microcomputer 31 determines that vibration has been detected is equal to the value of the amount of vibration applied to the portable device 3 at which the vibration sensor 34 is activated from a sleep state when exceeding the determination threshold. Alternatively, the vibration sensor 34 may be constantly active to output a detection signal to the microcomputer 31 that is indicative of the amount of vibration applied to the portable device 3 so that the microcomputer 31 checks the detection signal of the vibration sensor 34 and determines that vibration has been detected if the vibration amount indicated by the detection signal exceeds the determination threshold.

The microcomputer 31 has determination thresholds that are indicative of different vibration detection sensitivities. In this example, the determination thresholds include a first determination threshold that is used for a low sensitivity mode, a second determination threshold that is used for a standard sensitivity mode, and a third determination threshold that is used for a high sensitivity mode. The microcomputer 31 selects one determination threshold from the first to third determination thresholds and determines whether or not vibration is detected based on the selected determination threshold.

The operation of the portable device 3 will now be described.

As illustrated in FIG. 2, the state of the microcomputer 31 shifts among the low sensitivity mode, the standard sensitivity mode, and the high sensitivity mode. In the low sensitivity mode, the microcomputer 31 selects the first determination threshold by which detection of vibration is least likely to be determined. The microcomputer 31 determines whether or not vibration has been detected based on the selected first determination threshold. The first determination threshold indicates a first vibration detection sensitivity. In the low sensitivity mode, if the amount of vibration exceeds the first determination threshold and the microcomputer 31 determines that vibration is detected, the microcomputer 31 switches ON a function for receiving a polling signal with the LF reception circuit 32. If the amount of vibration does not reach the first determination threshold and the microcomputer 31 determines that vibration is not detected, the microcomputer 31 switches OFF the function for receiving a polling signal with the LF reception circuit 32.

In the low sensitivity mode, if the amount of vibration exceeds the first determination threshold and the microcomputer 31 determines that vibration has been detected, the microcomputer 31 shifts to the standard sensitivity mode. In the standard sensitivity mode, the microcomputer 31 selects the second determination threshold by which detection of vibration is more likely to be determined than the first determination threshold. The microcomputer 31 determines whether or not vibration has been detected based on the selected second determination threshold. That is, the second determination threshold is lower than the first determination threshold. Accordingly, the second determination threshold indicates a second vibration detection sensitivity that is higher than the first vibration detection sensitivity. In the standard sensitivity mode, if the amount of vibration exceeds the second determination threshold and the microcomputer 31 determines that vibration has been detected, the microcomputer 31 switches ON the function for receiving a polling signal with the LF reception circuit 32. If the amount of vibration does not reach the second determination threshold and the microcomputer 31 determines that vibration has not been detected, the microcomputer 31 switches OFF the function for receiving a polling signal with the LF reception circuit 32.

In the standard sensitivity mode, if the amount of vibration does not reach the second determination threshold and the microcomputer 31 does not determine that vibration has not been detected for a fixed period of time, the microcomputer 31 shifts to the low sensitivity mode and determines whether or not vibration has been detected based on the first determination threshold.

In the standard sensitivity mode, if the amount of vibration exceeds the second determination threshold and the microcomputer 31 determines that vibration has been detected, the microcomputer 31 switches ON the function for receiving a polling signal with the LF reception circuit 32. If the polling signal is actually received by the LF reception circuit 32, the microcomputer 31 shifts to the high sensitivity mode. In the high sensitivity mode, the microcomputer 31 selects the third determination threshold. The microcomputer 31 determines whether or not vibration has been detected based on the selected third determination threshold. The third determination threshold is lower than the second determination threshold. Accordingly, the third determination threshold indicates a third vibration detection sensitivity that is higher than the second vibration detection sensitivity. In the present embodiment, which is one non-restrictive example, the third determination threshold is set to a value by which the microcomputer 31 always determines that vibration is detected. In the high sensitivity mode, the microcomputer 31 always determines that vibration has been detected, and the microcomputer 31 always switches ON the function for receiving a polling signal with the LF reception circuit 32.

In the high sensitivity mode, if a polling signal is not received by the LF reception circuit 32, the microcomputer 31 shifts to the standard sensitivity mode and determines whether or not vibration has been detected based on the second determination threshold.

As illustrated in FIG. 3A, the portable device 3 is expected to be used in situations including a usage situation in a stored state, a usage situation outside the exterior communication area, and a usage situation inside the exterior communication area. In the usage situation in a stored state, the function for receiving a polling signal, which is an LF signal, is not necessary when reducing power consumption and improving security (refer to FIG. 3B). Accordingly, in the usage situation in a stored state, it is desirable that the microcomputer 31 be shifted to the low sensitivity mode and that the selected threshold for determining detection of vibration be the first determination threshold by which detection of vibration is least likely to be determined so that the function for receiving a polling signal is less likely to be switched ON. The present example is implemented in such a manner.

In contrast to the usage situation in a stored state, in the usage situation inside the exterior communication area, the function for receiving a polling signal, which is an LF signal, is necessary to improve convenience. Accordingly, in the usage situation inside the exterior communication area, it is desirable that the microcomputer 31 be shifted to the high sensitivity mode and that the selected threshold for determining detection of vibration be the third determination threshold by which detection of vibration is always determined so that the function for receiving a polling signal is always switched ON. The present example is implemented in such a manner.

In the usage situation outside the exterior communication area, which comes between the usage situation in a stored state and the usage situation inside the exterior communication area, it is desirable that the microcomputer 31 be shifted to the standard sensitivity mode that serves as an intermediate function between the low sensitivity mode and the high sensitivity mode.

The present embodiment has the following advantages.

(1) One of the determination thresholds is selected to change the vibration detection sensitivity. This allows for vibration detection to be performed with sensitivity that is in accordance with the usage situations.

(2) The vibration detection sensitivity is increased in the usage situation inside the exterior communication area so that detection of vibration is determined even when the vibration amount is small. In the high sensitivity mode that is suitable for the usage situation inside the exterior communication area, the microcomputer 31 determines that vibration has been detected even when the vibration amount is substantially zero. This allows stationary actions to be detected.

(3) Whether or not vibration has been detected is determined in the standard sensitivity mode and the low sensitivity mode in addition to the high sensitivity mode in accordance with the usage situations.

(4) Communication can be kept established with the vehicle 2 in the high sensitivity mode. Further, power consumed when waiting to receive a signal can be reduced and unnecessary establishment of communication can be restricted in the low sensitivity mode, and the standard sensitivity mode serves as the intermediate function.

(5) The low sensitivity mode determines whether or not vibration has been detected based on the first determination threshold by which detection of vibration is least likely to be determined. As long as the portable device 3 is stored in a stationary state, the detection of vibration is less likely to be determined even when vibration is generated in a household environment. Thus, the function for receiving a polling signal remains switched OFF.

(6) The high sensitivity mode determines whether or not vibration has been detected based on the third determination threshold by which detection of vibration is always determined. As long as the portable device 3 is in the exterior communication area, the function for receiving a polling signal remains switched ON.

(7) The standard sensitivity mode determines whether or not vibration has been detected based on the second determination threshold, which is less than the first determination threshold and greater than the third determination threshold. Thus, the vibration amount generated when moving such as when walking may be calculated from experiments or the like and a value slightly less than the calculated amount of vibration may be set as the second determination threshold so that the function for receiving a polling signal remains switched ON during walking. Accordingly, when an owner carrying the portable device 3 enters the exterior communication area, the portable device 3 immediately receives a polling signal. This improves responsiveness and convenience.

(8) The sensitivity is optimized in accordance with the usage situations as described above in advantages (5) to (7).

The above-described embodiment may be modified as follows.

The vibration sensor 34 may be an acceleration sensor or an angular velocity sensor.

The number of the determination thresholds needs not be three but may be two, four, or more.

The low-frequency LF signal is not limited to radio waves in the LF band.

The high-frequency RF signal is not limited to radio waves in the UHF band.

The standard sensitivity mode can be configured so that the microcomputer 31 does not determine the detection of vibration if the vibration applied to the portable device 3 is only generated when walking as a foot touches the ground and so that the microcomputer 31 determines the detection of vibration if the vibration applied to the portable device 3 is generated by a waving action or the like. In this case, the function for receiving a polling signal is switched OFF until the portable device 3 is waved as intended by the owner. This reduces power consumption and improves security in a walking usage situation as well as the usage situation in a stored state.

The portable device of the present invention may be applied to a SMART KEY SYSTEM in which the device serving as a communication peer of the portable device 3 is a building instead of or in addition to the vehicle 2. In this case, the front door or the like of the building transmits a polling signal and forms an indoor or outdoor communication area around the front door. When an owner carrying the portable device 3 enters the communication area, the portable device 3 automatically transmits a response signal in response to the polling signal and the front door is locked or unlocked if key authentication is accomplished. In a usage situation inside the indoor communication area, the portable device 3 may be stored inside the indoor communication area. Thus, it is desirable that measures be taken to determine whether or not vibration has been detected in the low sensitivity mode so that smart communication is established only when intended by the owner in the stored state.

1. A portable device including a vibration sensor, the portable device comprising:
a determination unit that determines that vibration is detected when an amount of vibration applied to the portable device exceeds a determination threshold that is indicative of a vibration detection sensitivity of the vibration sensor, wherein
the determination unit selects one of determination thresholds that are indicative of different vibration detection sensitivities and determines whether or not vibration is detected based on the selected determination threshold.

2. The portable device according to claim 1, comprising
a reception unit that receives a polling signal transmitted from a device serving as a communication peer of the portable device, wherein
when the reception unit receives the polling signal, the determination unit selects one of the determination thresholds that is indicative of a higher sensitivity than when the polling signal is not received by the reception unit and determines whether or not vibration is detected in a high sensitivity mode.

3. The portable device according to claim 2, wherein
when the reception unit does not receive the polling signal in the high sensitivity mode, the determination unit selects one of the determination thresholds that is indicative of a lower sensitivity than the high sensitivity mode and determines whether or not vibration is detected in a standard sensitivity mode, and
when the determination unit does not determine that vibration is detected for a fixed period of time in the standard sensitivity mode, the determination unit selects one of the determination thresholds that is indicative of a lower sensitivity than the standard sensitivity mode and determines whether or not vibration is detected in a low sensitivity mode.

4. The portable device according to claim 3, wherein
in the high sensitivity mode, the determination unit always determines that vibration is detected,
in the standard sensitivity mode or the low sensitivity mode, the determination unit determines that vibration is detected when an amount of vibration exceeding the corresponding determination threshold is applied to the portable device, and
the determination unit switches ON a function for receiving the polling signal with the reception unit when determining that vibration has been detected and switches OFF the function for receiving the polling signal with the reception unit when determining that vibration has not been detected.

5. The portable device according to claim 4, wherein
in the low sensitivity mode, the determination unit selects a first determination threshold from the determination thresholds,
in the standard sensitivity mode, the determination unit selects a second determination threshold from the determination thresholds by which detection of vibration is more likely to be determined than the first determination threshold, and
in the high sensitivity mode, the determination unit selects a third determination threshold from the determination thresholds by which detection of vibration is always determined.
